(19) United States
(12) Patent Application Publication
(10) Pub. No.: US 2018/0255973 A1
(43) Pub. Date: Sep. 13, 2018

(54) MOVABLE COOKING SURFACE

(71) Applicant: GHP Group, Inc., Niles, IL (US)

(72) Inventors: Robert Lang, Niles, IL (US); Daniel Choi, Niles, IL (US)

(73) Assignee: GHP Group, Inc., Niles, IL (US)

(21) Appl. No.: 15/455,447

(22) Filed: Mar. 10, 2017

(51) Int. Cl. A47J 37/07

(52) U.S. Cl. CPC A47J 37/0731; A47J 37/0763

(57) ABSTRACT

Disclosed is a cooking device having cooking surfaces that move with respect to the device or one another. The cooking surfaces can slide or otherwise move on, for example, rails to allow access to portions of the cooking device that would otherwise be obstructed by the cooking surfaces.

### TECHNICAL FIELD OF THE INVENTION

The present application relates generally to cooking surfaces. More particularly, the present application relates to a movable cooking surface that provides improved access to areas of a cooking device.

### BACKGROUND OF THE INVENTION

Grills and smokers (collectively “barbecues”), are well known in the art. These cooking devices allow users to cook food over an open flame or burning charcoal. The heat in a barbecue can be fueled by charcoal, wood, propane or other gas, or electric heat. Some smokers also include an area for wood chunks or chips that can be heated so as to emit smoke for additional flavoring of the meat during low temperature cooking.

Barbecues come in different shapes and sizes, for example, barrel, offset, “bullet,” kamado, or conventionally-shaped. These barbecues typically include grates or other cooking surfaces within the inside of the barbecue where meat or other food is cooked. The food then releases fat or juices to the lower area of the barbecue, which then needs to be cleaned. The lower area of the barbecue may also contain a pan for ashes or water, or an area where charcoal or wood chunks and chips can be held during cooking. Access to this lower area can therefore be advantageous for the user of the barbecue. Prior art barbecues require the removal of the cooking surface to access these lower areas.

While barbecues according to the prior art provide a number of advantageous features, they nevertheless have certain limitations. The presently disclosed embodiments seek to overcome certain of these limitations and other drawbacks of the prior art, and to provide new features not heretofore available. A full discussion of the features and advantages of the presently disclosed embodiments is deferred to the following detailed description, which proceeds with reference to the accompanying drawings.

### SUMMARY OF THE INVENTION

The presently disclosed embodiments relate to a movable cooking surface system, for example a grate for a grill or smoker. The system can include a first set of rails for a first cooking surface, and a second set of rails for a second cooking surface. The first cooking surface and rails can be offset (e.g., below or above) with respect to the second cooking surface and rails so the surfaces can slide on the rails and not obstruct one another. One of the first or second rails can include a stop that the cooking surface abuts to prevent substantial movement beyond a certain point, and the other of the first and second rails can be a continuous rail extending the length or nearly the length of the barbecue, where the cooking surface rests freely on the rail and moves laterally within the rail.

The movement of the cooking surfaces on the rails allows access to lower areas of the barbecue by creating an opening where a standard cooking surface would otherwise be located. A user can then access objects in the lower area, for example an ash pan, water pan, charcoal, wood chips or chunks, or debris. The user can maintain or control cooking temperatures by adding more charcoal, wood chips or chunks, or by simply stoking the solid fuel to keep embers exposed for more heat. The user can also clean the barbecue easier by obtaining access to areas that were otherwise difficult to reach, and which often include an abundance of food waste, e.g., excess fat that has cooked off of meat. The cooking surface(s) can simply be slid to an open position to provide this access rather than requiring the complete removal of the cooking surface, which may be hot, covered in cooking debris, or otherwise not conveniently removable.

In particular, the presently disclosed embodiments are described below, and include a cooking device including a first rail, a first cooking surface movably disposed on the first rail, a second rail, and a second cooking surface movably disposed on the second rail. The cooking device can further include a body having an upper body portion and a lower body portion movably coupled to the upper body portion, the first and second rails being coupled to the lower body portion. The first and second cooking surfaces are disposable in an open or closed position. When in the open position at least one of the first and second cooking surfaces is moved so as to expose an opening that allows access to a portion of the lower body portion, and when in the closed position the first and second cooking surfaces are disposed such that at least one of the first and second cooking surfaces hinders access to a portion of the lower body portion.

Further disclosed is a cooking device including a first rail, a first cooking surface disposed on the first rail, a second rail, a second cooking surface slidably disposed on the second rail. The cooking device can include a body having an upper body portion and a lower body portion movably coupled to the upper body portion, the first and second rails being coupled to the lower body portion. The first and second cooking surfaces are disposable in an open or closed position, wherein when in the open position at least one of the first and second cooking surfaces is moved so as to expose an opening that allows access to a portion of the lower body portion, and wherein when in the closed position the first and second cooking surfaces are disposed such that at least one of the first and second cooking surfaces hinders access to a portion of the lower body portion.

Also disclosed is a cooking surface system including a first rail, a first cooking surface disposed on the first rail, a second rail, and a second cooking surface movably disposed on the second rail. The cooking surface system can further include a body portion, where the first rail and the second rail are coupled to the body portion. The first and second cooking surfaces are disposable in an open or closed position. When in the open position at least one of the first and second cooking surfaces is moved so as to expose an opening that allows access to a portion of the body portion, and when in the closed position the first and second cooking surfaces are disposed such that at least one of the first and second cooking surfaces hinders access to a portion of the body portion.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a front perspective view of a cooking device according to at least some of the presently disclosed embodiments.

FIG. 2 is a front perspective view of a cooking device with the first and second cooking surfaces removed according to at least some of the presently disclosed embodiments.

FIG. 3 is an enlarged view of the first and second rails according to at least some of the presently disclosed embodiments.

FIG. 4 is a front view of a cooking device according to at least some of the presently disclosed embodiments.

FIG. 5 is a side view of a cooking device according to at least some of the presently disclosed embodiments.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

Disclosed is a cooking device or system having a plurality of cooking surfaces, for example, a grate for a grill or smoker. The cooking surfaces can slide or otherwise move on, for example, rails. The rails can be offset with one another to allow movement of one or more cooking surface without the cooking surfaces abutting or otherwise preventing movement of one another along the rails. One or more of the cooking surfaces can also include a stop that the upper surface abuts to prevent substantial movement beyond a certain point. In at least some embodiments, the lower of the first and second rails can be a continuous rail extending substantially the length of the barbecue to allow full lateral movement of the cooking surface.

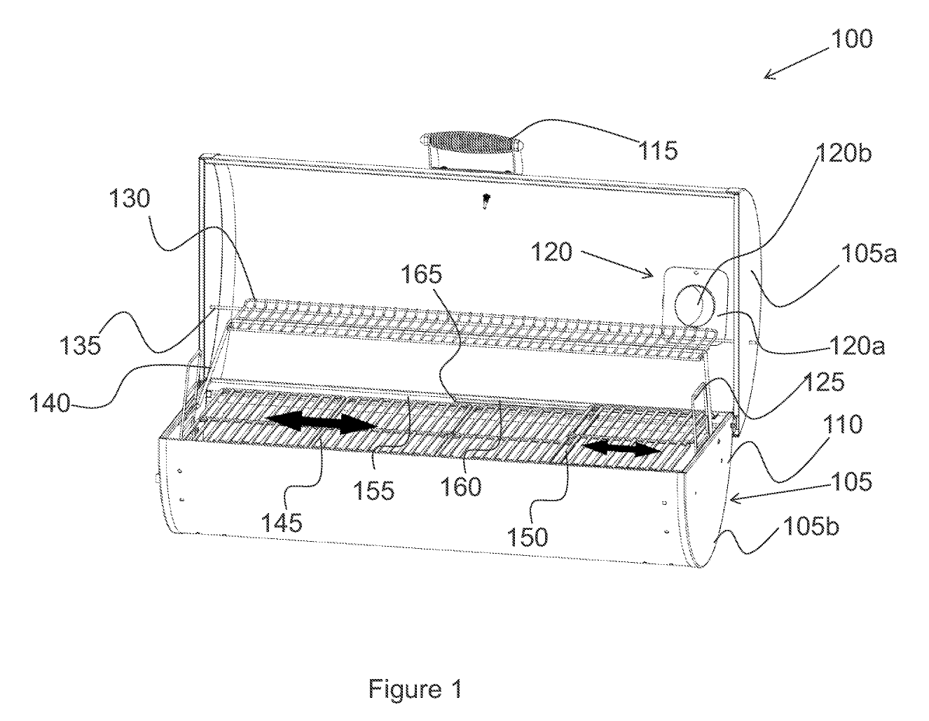

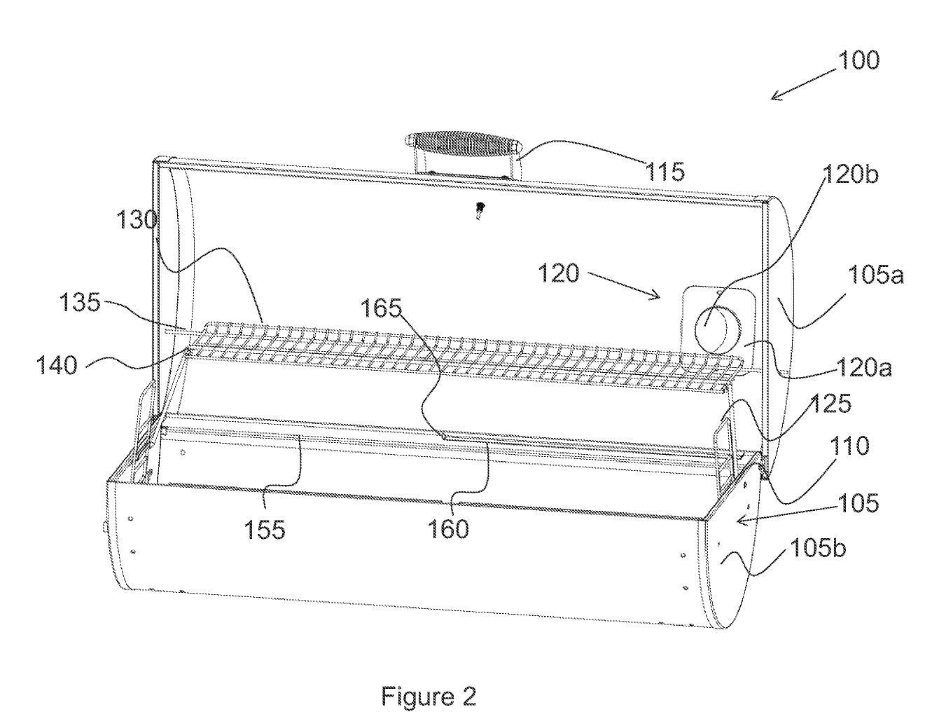

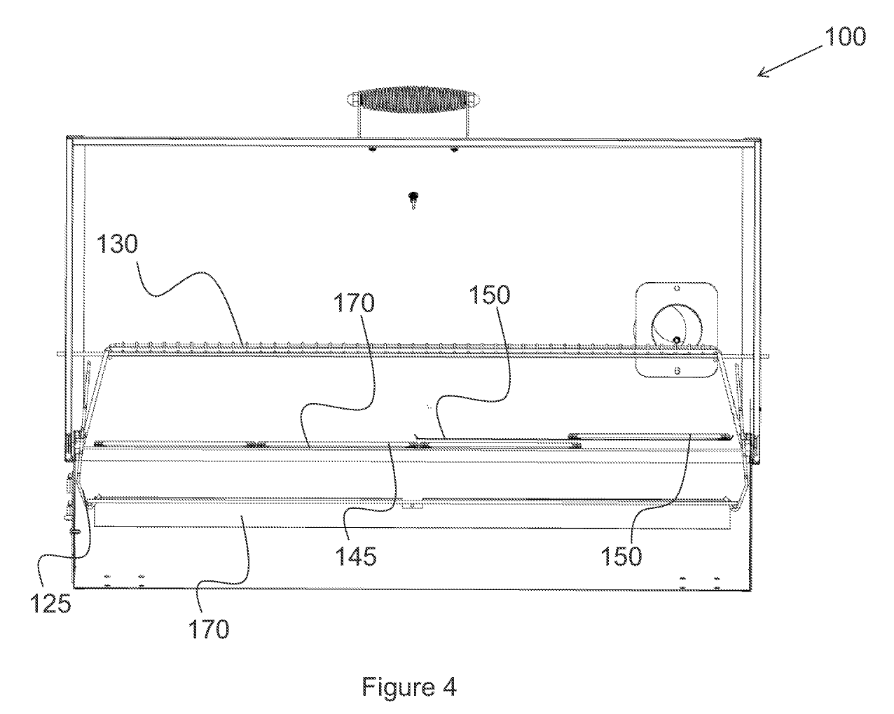

As shown in FIGS. 1-5, the cooking device 100 includes a body 105, for example a barrel body, with an upper body 105a and a lower body 105b. The upper body 105a is movable with respect to the lower body 105b via hinges or other such rotational or movable mechanisms. As shown, the upper body 105a is rotatable with respect to the lower body 105b via one or more hinges 110. The upper body 105a can be opened by a handle 115 located on the upper body 105a to hingedly move the upper body 105a relative to the lower body 105b and expose the interior of the body 105.

The body 105 can include a smoke stack 120 to allow smoke or excess heat to exhaust from the cooking device 100, and to provide air flow for the combustion of charcoal or other fuel. As discussed below in more detail, charcoal can benefit from both an air inlet and outlet due to the requirement of oxygen for the combustion of the charcoal and the benefits of a constant airflow over the charcoal to drive the flames into the unburned coal and wood chunks or chips. The smoke stack 120 helps with that air flow. The smoke stack 120 can be coupled to the upper body 105a by a flange 120a, and can further include a tube 120b extending from the flange to exhaust air or heat from the cooking device 100.

In some embodiments, the cooking device 100 is a smoker, charcoal grill, or other device that burns fuel resulting in ashes or other debris post-burning. The cooking device 100 can therefore include ash pan hangers 125 for holding an ash pan. The ash pan hangers 125 can be coupled to the lower body 105b and extend upward to allow a user to remove the ash pan when the cooking surfaces are removed or open. The ash pan hangers 125 can also be coupled to the ash pan itself, and not to the lower body 105b. In this manner, the ash pan hangers 125 can extend upward freely without any coupling other than to the ash pan, and the ash pan can rest in the lower body 105b with the ash pan hangers 125 extending upward for access by a user.

The cooking device 100 can include a warming rack 130 for placing food when the food is fully cooked, but where, for example, other food is still being cooked on the cooking device. The warming rack 130 can be any structure similar to the cooking surfaces, and in a preferred embodiment is a rack with openings to allow the flow of air around the food being warmed. The warming rack 130 can be pivotably coupled to the upper body 105a via a pivot rod 135, that can extend partially or (as shown) completely across the length of the body 105. The warming rack 130 can also include legs 140 that connect to the lower body 105b or to elements located near the lower body 105b. In this manner, the warming rack 130 can pivot and be located away from the cooking area of the lower body 105b so as to allow access to the food being cooked or to other portions of the lower body 105b.

As shown, the cooking device 100 can include a first cooking surface 145 and a second cooking surface 150. The cooking surfaces 145, 150 are shown as being located within the lower body 105b, but the present invention is not so limited. As shown, the cooking surfaces 145, 150 can slide within first and second rails 155, 160 to allow access to lower portions of the lower body 105b. For example, the first cooking surface 145 is shown in the figures and exemplary embodiments as being lower than the second cooking surface 150. While the present invention is not so limited, the offset nature of the cooking surfaces 145, 150 can allow them to slide or otherwise move within the rails 155, 160 and move one or both surfaces 145, 150 away from obstructing access to the lower portion of the lower body 105b. For example, the user can slide the second cooking surface 150 along the second rail 160 to expose an opening in the area in which the second cooking surface 150 previously was located. The user can then access contents of the lower body 105b within that opening, or the first cooking surface 145 can then slide towards the opening created by the now-moved second cooking surface 150 to expose an opening below the first cooking surface 145 where contents in the lower body 105b can be accessed. The user can therefore access all areas of the lower body 105b without fully removing the first and second cooking surfaces 145, 150.

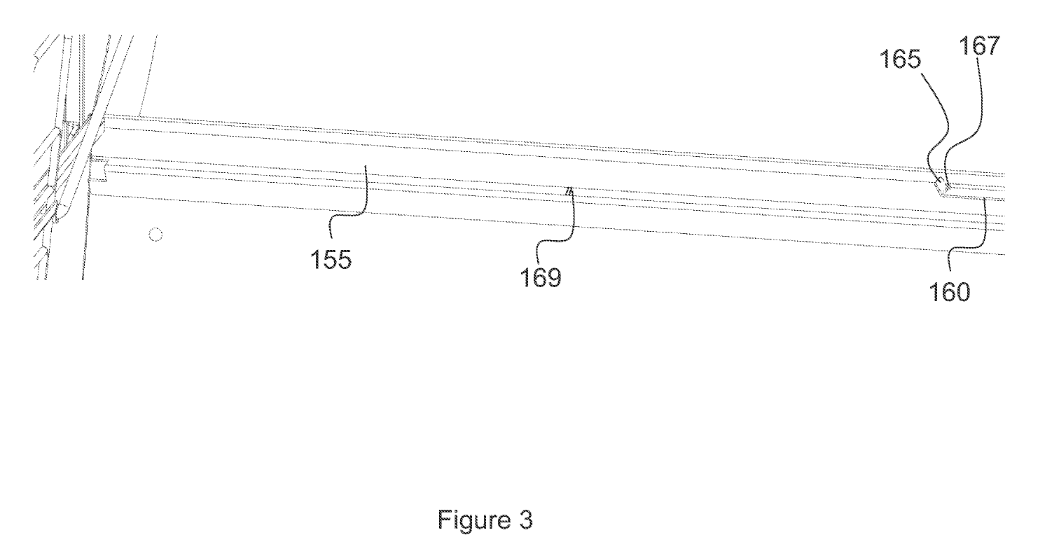

The second rail 160 can include a stop 165 located at an end of the rail located between two extreme ends of the body 105. This stop 165 can be any structure that substantially prevents or at least impedes movement of the second cooking surface 150 past the stop. As best shown in FIG. 3, the stop 165 can be a ramp or a piece of sheet metal that is perpendicular to the second rail 160 to prevent over-sliding of the second cooking surface 150. The second rail 160 can also be welded to the lower body 105b with a tack weld 167, where the tack weld 167 itself can act as all or a portion of the stop 165.

As shown in FIG. 3, the cooking device 100 can include a notch 169 on one of the first and second rails 155, 160 to temporarily suspend the first and second cooking surfaces 145, 150 at a point on the rail 155, 160. The notch 169 is designed to allow the cooking surface 145, 150 within the rail 155, 160 to rest at an intermediate point between the extreme ends of the rail 155, 160 to allow the cooking surface 145, 150 to softly lock in place at a designated point, but to be able to be moved easily thereafter. The notch 169 need not be a notch per se, but can be a ball detent mechanism, an area of additional friction, a structure that complements a structure of the cooking surfaces 145, 150, or any other structure that allows the cooking surface 145, 150 to temporarily maintain its position or softly lock in place at an intermediate point between the extreme ends of the rail 155, 160.

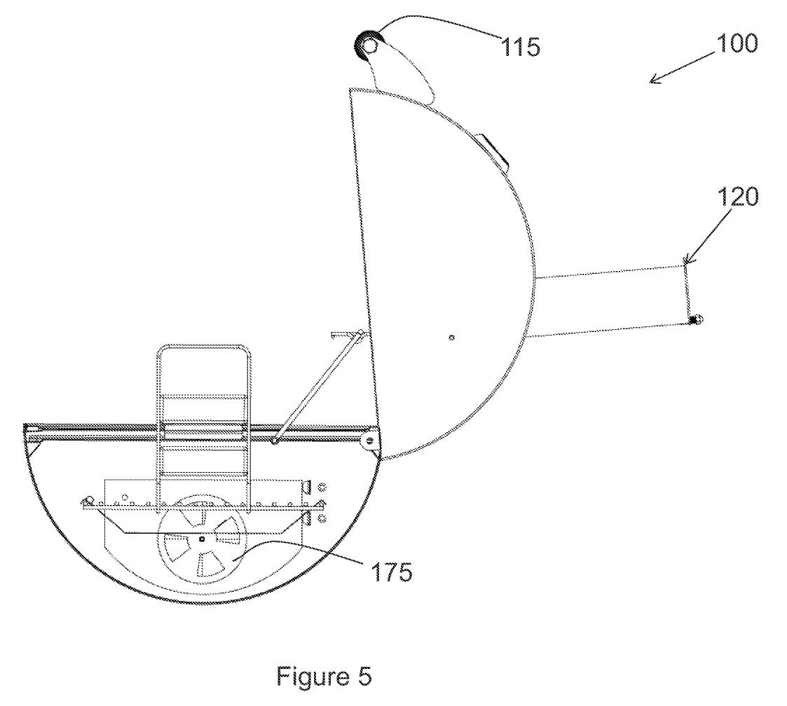

As shown in FIG. 5, the cooking device 100 can include a vent 175 for selectively allowing air into the lower body 105b and providing oxygen to the charcoal or other fuel located in the lower body 105b. For example, the vent 175 can rotate and openings within the vent 175 can align with openings in the lower body 105b to allow air to pass into the cooking device. If the temperature is too high, the user can close the vents to prevent substantial amounts of oxygen from entering. If the temperature is too low, the user can open the vent to allow more oxygen to flow into the lower body 105b and ignite the charcoal or other fuel.

The exemplary embodiments above describe the cooking surfaces 150, 155 as being slidably movable with respect to the rails 155, 160. However, the present invention is not so limited and the cooking surfaces 150, 155 can be movable in a hinged orientation, a ball bearing connection, or any other manner.

The term “cooking surface” is used in at least some of the above exemplary embodiments to reference a grate on a grill or smoker. However, the cooking surface of the present invention could include a grate, flat griddle, hot stone, pizza stone, pan, cookie sheet, pot, or any other device capable of holding food while cooking.

At least some of the exemplary embodiments above are for cooking devices such as grills or smokers. However, the term “cooking device” is not so limited and can include a cooktop, range, wall oven, freestanding oven, griddle, camp fire, burner, microwave, or any other device or structure that cooks food.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A cooking device comprising:
a first rail;
a first cooking surface movably disposed on the first rail;
a second rail;
a second cooking surface movably disposed on the second rail;
a body having an upper body portion and a lower body portion movably coupled to the upper body portion, the first and second rails being coupled to the lower body portion;
wherein the first and second cooking surfaces are disposable in an open or closed position, wherein when in the open position at least one of the first and second cooking surfaces is moved so as to expose an opening that allows access to a portion of the lower body portion, and wherein when in the closed position the first and second cooking surfaces are disposed such that at least one of the first and second cooking surfaces hinders access to a portion of the lower body portion.

2. The cooking device according to claim 1, wherein the first cooking surface is offset with respect to the second cooking surface.

3. The cooking device according to claim 2, wherein the first cooking surface is located below the second cooking surface.

4. The cooking device according to claim 1, further comprising a stop located on at least one of the first and second rails, wherein the stop is structured to hinder movement of the first or second cooking surface.

5. The cooking device according to claim 4, further comprising a tack weld proximate the stop and structured to hinder movement of the first or second cooking surface.

6. The cooking device according to claim 1, further comprising a notch located between the extreme ends of the first and second rails, wherein the notch hinders movement of the first or second cooking surface.

7. The cooking device according to claim 1, wherein the first cooking surface extends adjacent to or overlaps with the second cooking surface when the first and second cooking surfaces are in the closed position.

8. A cooking device comprising:
a first rail;
a first cooking surface disposed on the first rail;
a second rail;
a second cooking surface slidably disposed on the second rail;
a body having an upper body portion and a lower body portion movably coupled to the upper body portion, the first and second rails being coupled to the lower body portion;
wherein the first and second cooking surfaces are disposable in an open or closed position, wherein when in the open position at least one of the first and second cooking surfaces is moved so as to expose an opening that allows access to a portion of the lower body portion, and wherein when in the closed position the first and second cooking surfaces are disposed such that at least one of the first and second cooking surfaces hinders access to a portion of the lower body portion.

9. The cooking device according to claim 8, wherein the first cooking surface is offset with respect to the second cooking surface.

10. The cooking device according to claim 9, wherein the first cooking surface is located below the second cooking surface.

11. The cooking device according to claim 8, further comprising a stop located on at least one of the first and second rails, wherein the stop is structured to hinder movement of the first or second cooking surface.

12. The cooking device according to claim 11, further comprising a tack weld proximate the stop and structured to hinder movement of the first or second cooking surface.

13. The cooking device according to claim 8, further comprising a notch located between the extreme ends of the first and second rails, wherein the notch hinders movement of the first or second cooking surface.

14. The cooking device according to claim 8, wherein the first cooking surface extends adjacent to or overlaps with the second cooking surface when the first and second cooking surfaces are in the closed position.

15. The cooking device according to claim 8, wherein the first cooking surface is movably disposed on the first rail.

16. A cooking surface system comprising:
a first rail;
a first cooking surface disposed on the first rail;
a second rail;
a second cooking surface movably disposed on the second rail;
a body portion, wherein the first rail and the second rail are coupled to the body portion;
wherein the first and second cooking surfaces are disposable in an open or closed position, wherein when in the open position at least one of the first and second cooking surfaces is moved so as to expose an opening that allows access to a portion of the body portion, and wherein when in the closed position the first and second cooking surfaces are disposed such that at least one of the first and second cooking surfaces hinders access to a portion of the body portion.

17. The cooking surface system according to claim 16, wherein the first cooking surface is offset with respect to the second cooking surface.

18. The cooking surface system according to claim 16, further comprising a stop located on at least one of the first and second rails, wherein the stop is structured to hinder movement of the first or second cooking surface.

19. The cooking surface system according to claim 16, further comprising an upper body portion and wherein the body portion is a lower body portion.

20. A cooking device comprising the cooking surface system according to claim 16.
